(19) United States
(12) Patent Application Publication
(10) Pub. No.: US 2015/0186880 A1
(43) Pub. Date: Jul. 2, 2015

(54) Systems and Methods for Safe Payments

(71) Applicant: Tencent Technology (Shenzhen) Company Limited, Shenzhen (CN)

(72) Inventor: Yumiao Zhang, Shenzhen (CN)

(21) Appl. No.: 14/592,366

(22) Filed: Jan. 8, 2015

Related U.S. Application Data
(63) Continuation of application No. PCT/CN2014/081019, filed on Jun. 27, 2014.

(30) Foreign Application Priority Data
Dec. 26, 2013 (CN) 201310733754.3

(51) Int. Cl. G06Q 20/40; G06Q 20/22

(52) U.S. Cl. CPC G06Q 20/40; G06Q 20/227; G06Q 20/4016

(57) ABSTRACT

Systems and methods are provided for safe payments. For example, a payment operation event of deducting a preset amount initiated by a payer account based on a third-party payment platform is received; first feature information of the payer account and second feature information of a corresponding payee account are acquired; the preset amount is deducted from a first balance of the payer account according to the payment operation event; if the payment operation event is valid is determined according to the first feature information of the payer account and the second feature information of the payee account; and in response to the payment operation event being determined to be valid, the preset amount is added to a second balance of the payee account.

### CROSS-REFERENCES TO RELATED APPLICATIONS

The application claims priority to Chinese Patent Application No. 201310733754.3, filed. Dec. 26, 2013, incorporated by reference herein for all purposes.

### BACKGROUND OF THE INVENTION

Certain embodiments of the present invention are directed to computer technology. More particularly, some embodiments of the invention provide systems and methods for network technology. Merely by way of example, some embodiments of the invention have been applied to online payment. But it would be recognized that the invention has a much broader range of applicability.

Currently, when a payer account performs instant online payment based on a third-party payment platform, a target amount is often transferred from the payer account to the third-party payment platform and the third-party payment platform transfers the target amount from the payer account into a payee account on a real-time basis or after a certain waiting time. The payer account usually does not need to initiate an instruction to confirm the payment based on the third-party payment platform.

For the instant online payment, the third-party payment platform often checks the operation of the payer account and judges if the payment is valid when the target amount is transferred from the payer account to the third-party payment platform. Such a checking operation on the part of the third-party payment platform often extends the data processing time and the waiting time of payment of the payer account. Moreover, the third-party payment platform often needs to simultaneously check if the payment operations of all payer accounts are valid when many payer accounts transfer funds to the third-party payment platform concurrently, which may delay the payment operations of the payer accounts and may even cause the server to break down. However, the safety of online payment may be severely affected if the payment operations of the payer accounts are not checked.

Hence it is highly desirable to improve the techniques for safe payments.

### BRIEF SUMMARY OF THE INVENTION

According to one embodiment, a method is provided for safe payments. For example, a payment operation event of deducting a preset amount initiated by a payer account based on a third-party payment platform is received; first feature information of the payer account and second feature information of a corresponding payee account are acquired; the preset amount is deducted from a first balance of the payer account according to the payment operation event; if the payment operation event is valid is determined according to the first feature information of the payer account and the second feature information of the payee account; and in response to the payment operation event being determined to be valid, the preset amount is added to a second balance of the payee account.

According to another embodiment, a server for safe payments includes: an information acquisition module configured to receive a payment operation event of deducting a preset amount initiated by a payer account based on a third-party payment platform and acquire first feature information of the payer account and second feature information of a corresponding payee account; an amount deduction module configured to deduct the preset amount from a first balance of the payer account according to the payment operation event; a safety verification module configured to determine if the payment operation event is valid according to the first feature information of the payer account and the second feature information of the payee account; and an amount adjustment module configured, in response to the payment operation event being determined to be valid, to add the preset amount to a second balance of the payee account.

According to yet another embodiment, a method is provided for safe payments. A client detects a payment operation event of deducting a preset amount initiated by a payer account based on a third-party payment platform; the client sends the payment operation event to a server; the server receives the payment operation event; the server acquires first feature information of the payer account and second feature information of a corresponding payee account; the server deducts the preset amount from a first balance of the payer account according to the payment operation event; the server determines if the payment operation event is valid according to the first feature information of the payer account and the second feature information of the payee account; and in response to the payment operation event being determined to be valid, the server adds the preset amount to a second balance of the payee account.

In one embodiment, a system for safe payments includes: a server and a client corresponding to a payer account. The client is configured to detect a payment operation event of deducting a preset amount initiated by the payer account based on a third-party payment platform and send the payment operation event to a server. The server is configured to: receive the payment operation event; acquire first feature information of the payer account and second feature information of a corresponding payee account; deduct the preset amount from a first balance of the payer account according to the payment operation event; determine if the payment operation event is valid according to the first feature information of the payer account and the second feature information of the payee account; and in response to the payment operation event being determined to be valid, add the preset amount to a second balance of the payee account.

In another embodiment, a non-transitory computer readable storage medium includes programming instructions for safe payment. The programming instructions are configured to cause one or more data processors to execute certain operations. For example, a payment operation event of deducting a preset amount initiated by a payer account based on a third-party payment platform is received; first feature information of the payer account and second feature information of a corresponding payee account are acquired; the preset amount is deducted from a first balance of the payer account according to the payment operation event; if the payment operation event is valid is determined according to the first feature information of the payer account and the second feature information of the payee account; and in response to the payment operation event being determined to be valid, the preset amount is added to a second balance of the payee account.

For example, the devices, servers, systems and methods disclosed herein are configured for safe online payments to reduce a time period for a server to process payments of a payer account and increase the safety of online payments. In another example, the devices, servers, systems and methods disclosed herein are configured to verify safety of online payment when a server adds a preset amount to a payee account to reduce a time period of the server's processing of a payer account's payment operations, enhance human-machine interactions, reduce the pressure on the server and thus enhance the safety of online payment.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for safe payments according to one embodiment of the present invention.

FIG. 2(A), FIG. 2(B) and FIG. 2(C) are simplified diagrams showing user interfaces for safe payments according to some embodiments of the present invention.

FIG. 3 is a simplified diagram showing an information interface for safe payments according to one embodiment of the present invention.

FIG. 4 is a simplified diagram showing a verification process as part of a method for safe payments according to one embodiment of the present invention.

FIG. 5 is a simplified diagram showing a method for safe payments according to another embodiment of the present invention.

FIG. 6 is a simplified diagram showing a server for safe payments according to one embodiment of the present invention.

FIG. 7 is a simplified diagram showing a server for safe payments according to another embodiment of the present invention.

FIG. 8 is a simplified diagram showing a method for safe payments according to another embodiment of the present invention.

FIG. 9 is a simplified diagram showing a method for safe payments according to yet another embodiment of the present invention.

FIG. 10 is a simplified diagram showing a system for safe payments according to one embodiment of the present invention.

FIG. 11 is a simplified diagram showing an operating environment for the system as shown in FIG. 10 according to one embodiment of the present invention.

### DETAILED DESCRIPTION OF THE INVENTION

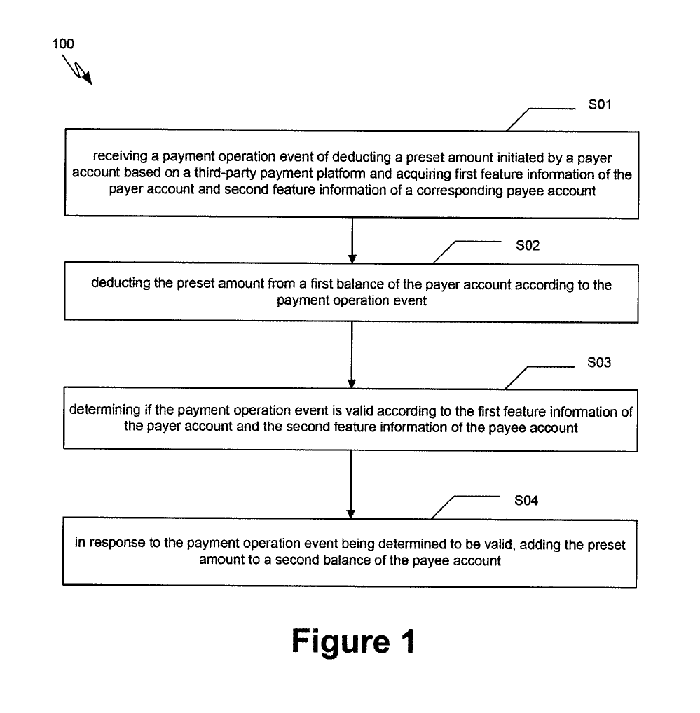

FIG. 1 is a simplified diagram showing a method for safe payments according to one embodiment of the present invention. The diagram is merely an example, which should not unduly limit the scope of the claims. One of ordinary skill in the art would recognize many variations, alternatives, and modifications. The method 100 includes at least processes S01-S04.

According to one embodiment, the process S01 includes: receiving a payment operation event of a preset amount initiated by a payer account based on a third-party payment platform and acquiring first feature information of the payer account and second feature information of a corresponding payee account. For example, upon receipt of a payment operation event of a preset amount initiated by a payer account based on a third-party payment platform, a server corresponding to the third-party payment platform acquires the first feature information of the payer account and the second feature information of the payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

According to another embodiment, the process S02 includes: deducting the preset amount from the first balance of the payer account according to the payment operation event. For example, the server deducts the preset amount corresponding to the payment operation event from the payer account on a real-time basis according to the acquired feature information of the payer account and the payee account but does not add the preset amount to the payee account simultaneously. As an example, the server freezes the payment operation executed by the payer account and delays adding the same amount to the payee account after the payer account completes the payment operation and before the server notifies the payee account.

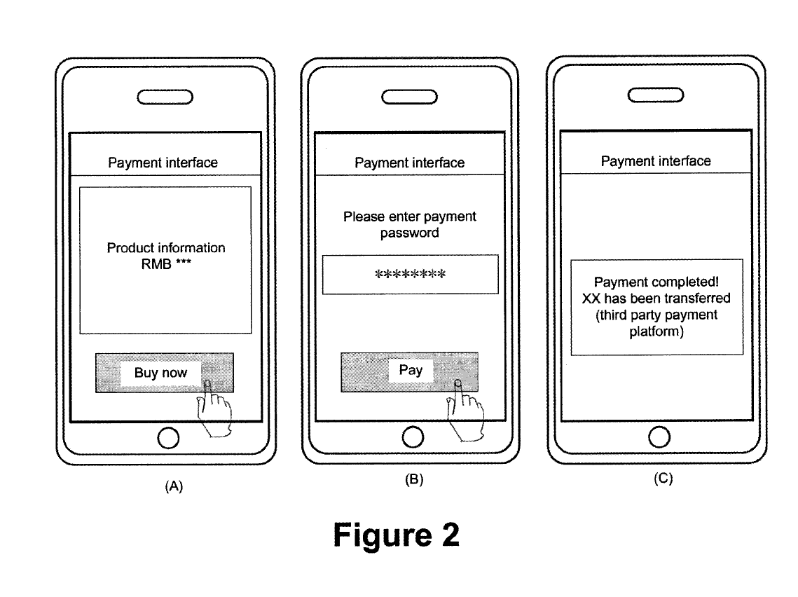

FIG. 2(A), FIG. 2(B) and FIG. 2(C) are simplified diagrams showing user interfaces for safe payments according to some embodiments of the present invention. The diagrams are merely examples, which should not unduly limit the scope of the claims. One of ordinary skill in the art would recognize many variations, alternatives, and modifications.

According to one embodiment, the client detects user operations on a user interface as shown in FIG. 2(A). For example, a user clicks on a functional control component (e.g., a button) “buy now” as shown in FIG. 2(A) to buy a product from an online shopping mall, which is received by a server, according to certain embodiments. As shown in FIG. 2(B), a payment interface is displayed, in some embodiments. For example, the user enters a corresponding paying password and clicks on another functional control component (e.g., a button) “pay” on the payment interface to initiate a payment operation event. As an example, the server performs safety verification on the payment before adding the preset amount to the payee account. After receiving the payment operation event initiated by the payer account based on the functional control component “pay,” the server deducts the preset amount from the first balance of the payer account on a real-time basis and displays on a client of the payer account the first balance of the payer account after the deduction. For example, for the user of the payer account, the payment operations of the payer account are processed on a real-time basis, hence improving the operating experiences of the user corresponding to the payer account.

According to one embodiment, when receiving a payment operation event of RMB 100,000 initiated by a payer account A based on a third-party payment platform (e.g., Tenpay), a server deducts the amount of RMB 100,000 from the payer account A on a real-time basis. For example, instead of adding the RMB 100,000 to the corresponding payee account B immediately, the server freezes the payment operation in a subsequent stage of adding the amount of RMB 100,000 to the payee account so as to verify and ensure the safety of the payment operation event initiated by the payer account.

Referring back to FIG. 1, the process S03 includes: verifying if the payment operation event is valid according to the first feature information of the payer account and the second feature information of the payee account, according to certain embodiments. For example, the server verifies the payment operation event initiated by the payer account according to the first feature information of the payer account and the second feature information of the payee account after the server forbids adding the preset amount to the payee account included in the second feature information of the payee account (e.g., before the server adds the preset amount to the payee account). In some embodiments, verification of the server on the payment operation event initiated by the payer account according to the first feature information of the payer account and the second feature information of the payee account includes certain operations. For example, the server makes a general assessment of the payment operation event initiated by the payer account according to the acquired feature information of the payer account and the payee account to see if the event directs towards a phishing website or is a malicious event set up by a hacker that exploits system vulnerability. As an example, the server identifies that the payer account does not select any valid commodity information before adding a large amount to an account on a third-party payment platform (e.g., Tenpay) that hasn't passed any safety verification (e.g., real name authentication). Then the server calls all operating data corresponding to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server pushes the information to a background maintenance client where one or more background technicians make a general technical assessment on the information and return a verification result to the server. The server then saves the verification result. Other manners of verification can be implemented, according to some embodiments.

According to one embodiment, the process S04 includes: adding the preset amount to the second balance of the payee account if the payment operation event is valid. For example, the server adds the preset amount to the second balance of the payee account if the verification result indicates that the payment operation event is valid. As an example, the server adds the preset amount to the second balance of the payee account if the payment operation event is verified valid. In another example, if the payment operation event is verified invalid, the server refunds the deducted preset amount to the payer account and adds the preset amount to the first balance of the payer account, thus resuming the second balance of the payee account. In yet another example, the server sends a prompt indicating possible safety risk to the payer account if the validity of the payment operation event cannot be determined.

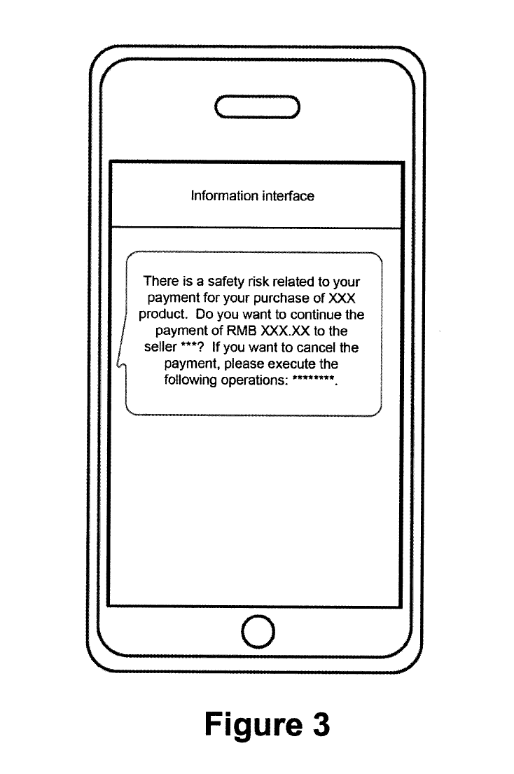

FIG. 3 is a simplified diagram showing an information interface for safe payments according to one embodiment of the present invention. The diagrams are merely examples, which should not unduly limit the scope of the claims. One of ordinary skill in the art would recognize many variations, alternatives, and modifications.

As shown in FIG. 3, a prompt that is pushed by a server and displayed on a client of a payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the server sends help information to one or more background technicians who then make a general technical assessment on the information and return a verification result to the server. In another example, the server then executes the corresponding adjustment operations according to the verification result transmitted by the background technicians. In yet another example, the server adds the preset amount to the second balance of the payee account if the verification result transmitted from the background technicians shows that the payment operation event is valid. In yet another example, the server refunds the deducted preset amount to the payer account if the verification result transmitted from the background technicians shows that the payment operation event is invalid. In yet another example, if the verification result shows that the payment operation event is invalid, the server refunds the deducted preset amount to the payer account, adds the preset amount to the first balance of the payer account and sends a corresponding prompt to the payer account. As an example, the prompt includes: “Your *** operation may encounter a safety risk. The amount of XXX you paid has been refunded to your account ******.”

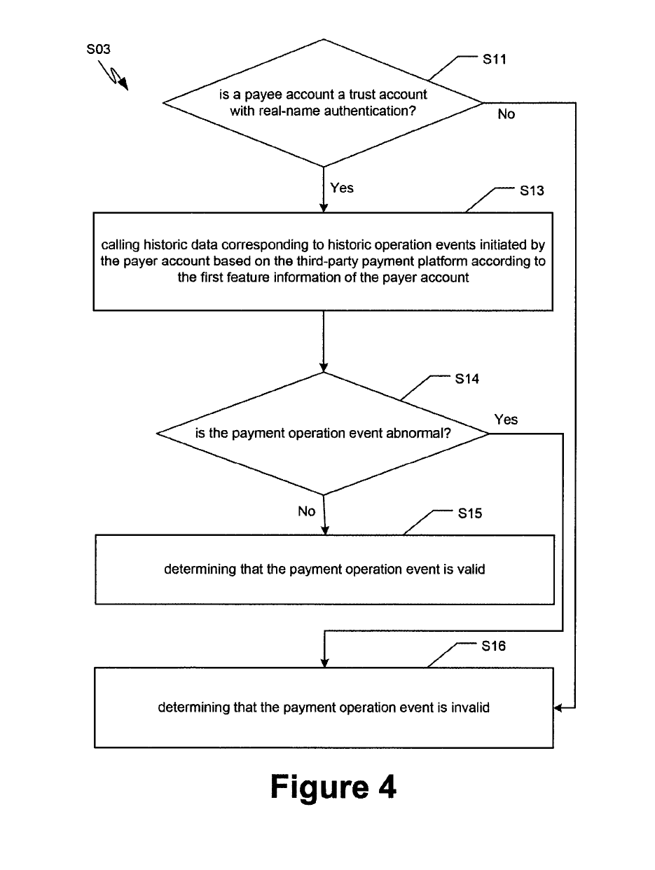

FIG. 4 is a simplified diagram showing a verification process as part of a method for safe payments according to one embodiment of the present invention. The diagrams are merely examples, which should not unduly limit the scope of the claims. One of ordinary skill in the art would recognize many variations, alternatives, and modifications. The verification process S03 includes at least processes S11-S16.

According to one embodiment, the process S11 includes: determining if a payee account is a trust account with real-name authentication according to the second feature information of the payee account. For example, if the payee account is a trust account with real-name authentication, the process S12 is executed. In another example, if the payee account is not a trust account with real-name authentication, the process, the process S13 is executed.

According to another embodiment, the process S12 includes: determining the payment operation event as invalid. For example, the server determines that the payee account needs to pass real name authentication so as to ensure financial safety, e.g., the payee account being associated with valid identity information. As an example, a payee account corresponds to a debit card or a credit card issued by China UnionPay which is associated with a real identity card number and a telephone number upon registration. In another example, when verifying if a payment operation event initiated by the payer account is valid, the server determines if the corresponding payee account is a trust account with real-name authentication according to the acquired feature information of the payee account. If the payee account is not authenticated or if the payee account that is an authenticated account has been complained many times, the payee account is listed as a distrusted account and the server determines the payment operation event initiated by the payer account as invalid, according to some embodiments.

According to yet another embodiment, the process S13 includes, according to the first feature information of the payer account, calling historic data corresponding to historic operation events initiated by the payer account based on the third-party payment platform. For example, the process S14 includes: parsing the historic data to determine if the payment operation event is abnormal. If the payment operation event is abnormal, the process S12 is executed, and if the payment operation event is normal, the process S15 is executed, according to certain embodiments.

In one embodiment, the process S15 includes: verifying the payment operation event as valid. For example, when determining that the payee account is a trust account with real-name authentication, the server calls the historic data corresponding to the historic operation events that the payer account has initiated on the basis of the third-party payment platform according to the first feature information of the payer account. In another example, the historic operation events that the server calls corresponding to the payer account include all the historic operation events that the payer account has initiated from its registration with the third-party payment platform to date and also the historic operation events that the payer account has initiated on the basis of the third-party payment platform within the preset time period. In yet another example, the server calls the payment-related operation events that the payer account has initiated in order to improve the data processing efficiency of the server. In yet another example, the server makes a general assessment of the payment operation event initiated by the payer account according to all the historic data of the payer account. In yet another example, the server determines that the payment operation event initiated by the user is invalid if the server identifies any anomaly in the payment operation event. In yet another example, the server determines that the payment operation event initiated by the user is valid if the server identifies no anomaly in the payment operation event. In some embodiments, the server makes a general assessment of feature information of the payer account and the payee account and verifies if the payment operation event initiated by the payer account is valid or not, hence increasing the accuracy of the server's verification on the payment operation event.

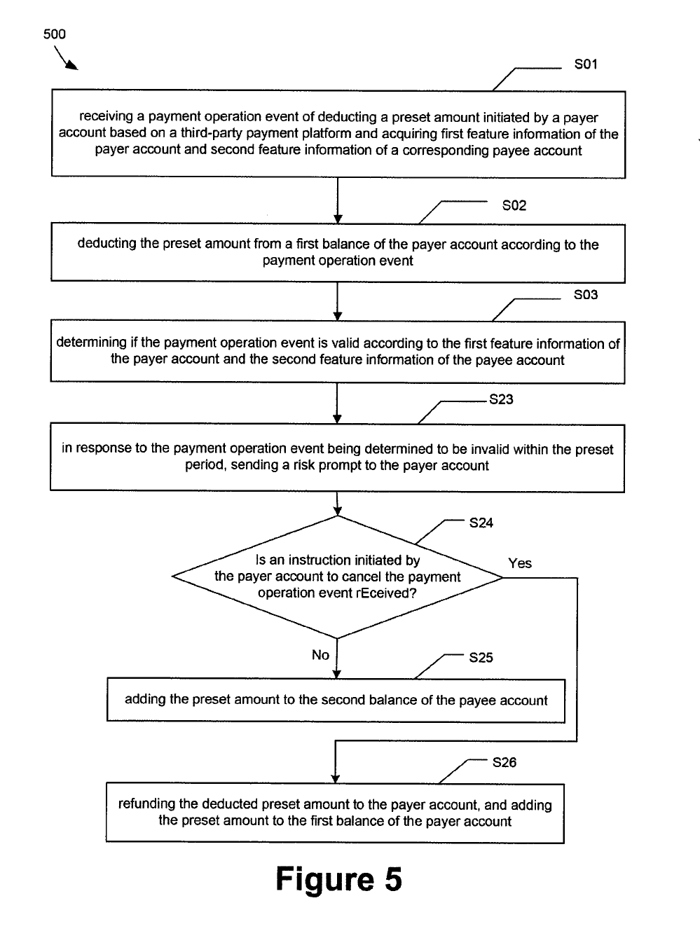

FIG. 5 is a simplified diagram showing a method for safe payments according to another embodiment of the present invention. The diagrams are merely examples, which should not unduly limit the scope of the claims. One of ordinary skill in the art would recognize many variations, alternatives, and modifications. The method 500 includes at least processes S01-S03 and processes S23-S26.

According to one embodiment, the process S01 includes: receiving a payment operation event of a preset amount initiated by a payer account based on a third-party payment platform and acquiring first feature information of the payer account and second feature information of a corresponding payee account. For example, upon receipt of a payment operation event of a preset amount initiated by a payer account based on a third-party payment platform, a server corresponding to the third-party payment platform acquires the first feature information of the payer account and the second feature information of the payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

According to another embodiment, the process S02 includes: deducting the preset amount from the first balance of the payer account according to the payment operation event. For example, the server deducts the preset amount corresponding to the payment operation event from the payer account on a real-time basis according to the acquired feature information of the payer account and the payee account but does not add the preset amount to the payee account with a preset time period. As an example, the server freezes the payment operation executed by the payer account within the preset time period (e.g., 24 hours) and delays adding the same amount to the payee account. In some embodiments, the preset time period may be set by the payer account, according to a default system setting or according to historic operation events of the payer account.

As shown in FIG. 2(A), a user interface is displayed, and a user clicks on a functional control component (e.g., a button) “buy now” to buy a product from an online shopping mall, which is received by a server, according to certain embodiments. As shown in FIG. 2(B), a payment interface is displayed, in some embodiments. For example, the user enters a corresponding paying password and clicks on another functional control component (e.g., a button) “pay” on the payment interface to initiate a payment operation event. As an example, the server performs safety verification on the payment before adding the preset amount to the payee account. After receiving the payment operation event initiated by the payer account based on the functional control component “pay,” the server deducts the preset amount from the first balance of the payer account on a real-time basis and displays on a client of the payer account the first balance of the payer account after the deduction. For example, for the user of the payer account, the payment operations of the payer account are processed on a real-time basis, hence improving the operating experiences of the user corresponding to the payer account.

According to one embodiment, when receiving a payment operation event of RMB 100,000 initiated by a payer account A based on a third-party payment platform (e.g., Tenpay), a server deducts the amount of RMB 100,000 from the payer account A on a real-time basis. For example, instead of adding the RMB 100,000 to the corresponding payee account B immediately, the server freezes the payment operation in a subsequent stage of adding the amount of RMB 100,000 to the payee account so as to verify and ensure the safety of the payment operation event initiated by the payer account.

Referring to FIG. 5, the process S03 includes: verifying if the payment operation event is valid according to the first feature information of the payer account and the second feature information of the payee account, according to certain embodiments. For example, the process S23 includes: according to the first feature information of the payer account and the second feature information of the payee account, sending a risk prompt to the payer account if the payment operation event is verified invalid within the preset time period. In another example, the server verifies the payment operation event initiated by the payer account according to the first feature information of the payer account and the second feature information of the payee account after the server forbids adding the preset amount to the payee account included in the second feature information of the payee account for a preset time period, which is a preset time period before the server adds the preset amount to the payee account. In order to prevent the user's normal payment operation from being affected by misjudgment of the server or any other reasons, the server freezes the payment operation to add the preset amount to the payee account within the preset time period, according to certain embodiments. Once the preset time period expires, the server unlocks the payment operation and executes the corresponding operations according to the verification result of the payment operation event. For example, the server executes the normal operating procedure of payment when the event is verified valid.

In some embodiments, verification of the server on the payment operation event initiated by the payer account according to the first feature information of the payer account and the second feature information of the payee account includes certain operations. For example, the server makes a general assessment of the payment operation event initiated by the payer account according to the acquired feature information of the payer account and the payee account to see if the event directs towards a phishing website or is a malicious event set up by a hacker that exploits system vulnerability. As an example, the server identifies that the payer account does not select any valid commodity information before adding a large amount to an account on a third-party payment platform (e.g., Tenpay) that hasn't passed any safety verification (e.g., real name authentication). Then the server calls all operating data corresponding to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server pushes the information to a background maintenance client where one or more background technicians make a general technical assessment on the information and return a verification result to the server. The server then saves the verification result. Other manners of verification can be implemented, according to some embodiments.

In certain embodiments, the server adjusts the payer account and the payee account according to the verification result of the payment operation event. For instance, the server adds the preset amount to the payee account if the payment operation event is verified valid. In another example, the server sends a prompt of possible safety risk to the payer account and the payer account sends an operation instruction so that the server can execute the corresponding payment operation according to a final operation instruction from the payer account if the payment operation event is determined to be invalid. As shown in FIG. 3, a prompt that is pushed by a server and displayed on a client of a payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the prompt is expected to remind the payer account to execute the corresponding operation, such as canceling the corresponding payment operation or continuing the corresponding payment operation.

According to one embodiment, the process S24 includes: determining if any instruction initiated by the payer account to cancel the payment operation event is received. For example, if no instruction initiated by the payer account to cancel the payment operation event is received, the process S25 is executed. In another example, if an instruction initiated by the payer account to cancel the payment operation event is received, the process S26 is executed. As an example, the process S25 includes: adding the preset amount to the second balance of the payee account. As another example, the process S26 includes: refunding the deducted preset amount to the payer account and adding the preset amount to the first balance of the payer account.

In some embodiments, the server identifies if any instruction initiated by the payer account to cancel the payment operation event is received. For example, the server adds the preset amount to the second balance of the payee account in order to prevent the user's normal payment operation from being affected by misjudgment of the server if the instruction initiated by the payer account to cancel the payment operation event is not received within the preset time period. In another example, the server notifies the payee account that the preset amount is already added to the second balance of the payee account after the server has added the preset amount to the second balance.

In certain embodiments, the server refunds the deducted preset amount to the payer account, adds the preset amount to the first balance of the payer account and resumes the second balance of the payee account if the server identifies that an instruction initiated by the payer account to cancel the payment operation event is received within the preset time period. For example, the server refunds the deducted preset amount to the payer account, adds the preset amount to the first balance of the payer account and sends a corresponding prompt to the payer account. As an example, the prompt may be as follows: “Your *** operation may encounter a safety risk. The amount of XXX you paid has been refunded to your account *****.” In some embodiments, when the server verifies that the payment operation event initiated by the payer account is invalid, the server notifies the payer account and allows the payer account to initiate an instruction to confirm if the payment operation is continued or not instead of executing the operation of refunding the preset amount to the payer account, hence preventing the user's normal payment operation from being affected by misjudgment of the server and improving the operating experiences of the user.

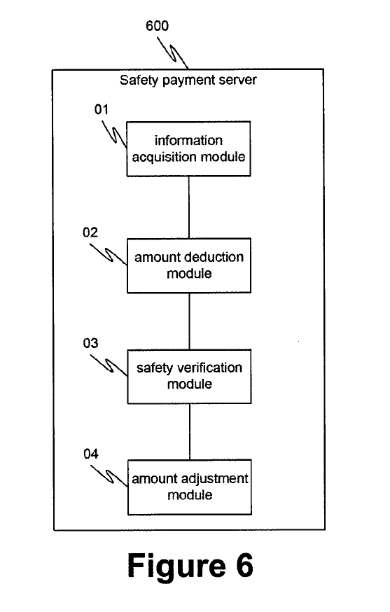

FIG. 6 is a simplified diagram showing a server for safe payments according to one embodiment of the present invention. The diagrams are merely examples, which should not unduly limit the scope of the claims. One of ordinary skill in the art would recognize many variations, alternatives, and modifications. The server 600 includes an information acquisition module 01, an amount deduction module 02, a safety verification module 03 and an amount adjustment module 04.

According to one embodiment, the information acquisition module 01 is configured to receive a payment operation event of instant payment of a preset amount initiated by a payer account based on a third-party payment platform and acquire first feature information of the payer account and second feature information of a corresponding payee account. For example, when receiving a payment operation event initiated by a payer account based on a third-party payment platform, the information acquisition module 01 acquires the first feature information of the payer account and the second feature information of the corresponding payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

According to another embodiment, the amount deduction module 02 is configured to deduct the preset amount from the first balance of the payer account according to the payment operation event. For example, the amount deduction module 02 deducts the preset amount corresponding to the payment operation event from the payer account on a real-time basis according to the first feature information of the payer account and the second feature information of the payee account acquired by the information acquisition module 01. In another example, the amount deduction module 02 does not add the preset amount to the payee account simultaneously. For instance, the amount deduction module 02 freezes the payment operation executed by the payer account and delays adding the same amount to the payee account after the payer account completes the payment operation and before the server notifies the payee account.

According to yet another embodiment, the information acquisition module 01 receives user operations on a user interface as shown in FIG. 2(A). For example, the user interface is displayed, and a user clicks on a functional control component (e.g., a button) “buy now” to buy a product from an online shopping mall, which is received by a server, according to certain embodiments. As shown in FIG. 2(B), a payment interface is displayed, in some embodiments. For example, the user enters a corresponding paying password and clicks on another functional control component (e.g., a button) “pay” on the payment interface to initiate a payment operation event. As an example, the server performs safety verification on the payment before adding the preset amount to the payee account. After the information acquisition module 01 receives the payment operation event initiated by the payer account based on the functional control component “pay,” the amount deduction module 02 deducts the preset amount from the first balance of the payer account on a real-time basis and displays on a client of the payer account the first balance of the payer account after the deduction, in some embodiments. For example, for the user of the payer account, the payment operations of the payer account are processed on a real-time basis, hence improving the operating experiences of the user corresponding to the payer account.

In one embodiment, when the information acquisition module 01 receives a payment operation event of RMB 100,000 initiated by a payer account A based on a third-party payment platform (e.g., Tenpay), the amount deduction module 02 deducts the amount of RMB 100,000 from the payer account A on a real-time basis. For example, instead of adding the RMB 100,000 to the corresponding payee account B immediately, the amount deduction module 02 freezes the payment operation in a subsequent stage of adding the amount of RMB 100,000 to the payee account so as to verify and ensure the safety of the payment operation event initiated by the payer account.

In another embodiment, the safety verification module 03 is configured to verify if the payment operation event is valid according to the first feature information of the payer account and the second feature information of the payee account. For example, the safety verification module 03 verifies the payment operation event initiated by the payer account according to the first feature information of the payer account and the second feature information of the payee account after the amount deduction module 02 forbids adding the preset amount to the payee account included in the second feature information of the payee account, which is before amount deduction module 02 adds the preset amount to the payee account.

In some embodiments, verification of the safety verification module 03 on the payment operation event initiated by the payer account according to the first feature information of the payer account and the second feature information of the payee account includes certain operations. For example, the safety verification module 03 makes a general assessment of the payment operation event of instant payment initiated by the payer account according to the first feature information of the payer account and the second feature information of the payee account acquired by the information acquisition module 01 to see if the event directs towards a phishing website or is a malicious event set up by any hacker utilizing any system vulnerability. In another example, the safety verification module 03 identifies that the payer account does not select any valid commodity information before adding a large amount to a third-party payment platform (e.g., Tenpay) account that hasn't passed any safety verification (e.g., real name authentication). Then the safety verification module 03 calls all operating data corresponding to the operation events initiated by the same payer account corresponding to the first feature information of the payer account based on the third-party payment platform (e.g., Tenpay) payment platform, calls the feature information of the corresponding payee account and makes a general analysis of the foregoing information to verify if the payment operation event initiated by the payer account is valid or not, according to some embodiments. For example, the safety verification module 03 pushes the information to a background maintenance client where one or more background technicians make a general technical assessment on the information and return a verification result to the server; the safety verification module 03 then saves the verification result. In some embodiments, the safety verification module 03 can perform verification in other manners.

In another embodiment, the amount adjustment module 04 is configured to add the preset amount to the second balance of the payee account if the payment operation event is valid. For example, the amount adjustment module 04 adjusts the account balance by the preset amount according to the verification result of the safety verification module 03, e.g., if the payment operation event is valid or not. In another example, the amount adjustment module 04 adds the preset amount to the payee account if the verification result of the safety verification module 03 indicates that the payment operation event is valid. For instance, the amount adjustment module 04 adds the preset amount to the second balance of the payee account if the payment operation event is verified valid. In another example, if the payment operation event is verified invalid, the amount adjustment module 04 refunds the deducted preset amount to the payer account and adds the preset amount to the first balance of the payer account, thus resuming the second balance of the payee account. In yet another example, the safety verification module 03 sends a prompt indicating possible safety risk to the payer account if the validity of the payment operation event cannot be determined.

As shown in FIG. 3, a prompt that is pushed by a server and displayed on a client of a payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the safety verification module 03 sends help information to one or more background technicians who then make a general technical assessment on the information and return a verification result to the server. In another example, the amount adjustment module 04 then executes the corresponding adjustment operations according to the verification result transmitted by the background technicians. In yet another example, the amount adjustment module 04 adds the preset amount to the second balance of the payee account if the verification result transmitted from the background technicians shows that the payment operation event is valid. In yet another example, the amount adjustment module 04 refunds the deducted preset amount to the payer account if the verification result transmitted from the background technicians shows that the payment operation event is invalid. In yet another example, if the verification result shows that the payment operation event is invalid, the amount adjustment module 04 refunds the deducted preset amount to the payer account, adds the preset amount to the first balance of the payer account and sends a corresponding prompt to the payer account. As an example, the prompt includes: “Your *** operation may encounter a safety risk. The amount of XXX you paid has been refunded to your account ******.”

According to one embodiment, the safety verification module 03 is further configured to: determine if the payee account is a trust account with real-name authentication according to the second feature information of the payee account. For example, if the payee account is determined as a trust account with real-name authentication, the safety verification module 03 is further configured to, according to the first feature information of the payer account, call historic data corresponding to historic operation events initiated by the payer account based on the third-party payment platform; parse the historic data to determine if the payment operation event is abnormal; verify that the payment operation event is invalid when the payment operation event is determined abnormal; and verify that the payment operation event is valid when the payment operation event is determined normal.

In some embodiments, the server determines that the payee account needs to pass real name authentication so as to ensure financial safety, e.g., the payee account being associated with valid identity information. As an example, a payee account corresponds to a debit card or a credit card issued by China UnionPay which is associated with a real identity card number and a telephone number upon registration. In another example, when verifying if a payment operation event initiated by the payer account is valid, the safety verification module 03 determines if the corresponding payee account is a trust account with real-name authentication according to the acquired feature information of the payee account. If the payee account is not authenticated or if the payee account that is an authenticated account has been complained many times, the payee account is listed as a distrusted account and the safety verification module 03 determines the payment operation event initiated by the payer account as invalid, according to some embodiments. For example, when determining that the payee account is a trust account with real-name authentication, the safety verification module 03 calls the historic data corresponding to the historic operation events that the payer account has initiated on the basis of the third-party payment platform according to the first feature information of the payer account. In another example, the historic operation events that the safety verification module 03 calls corresponding to the payer account include all the historic operation events that the payer account has initiated from its registration with the third-party payment platform to date and also the historic operation events that the payer account has initiated on the basis of the third-party payment platform within the preset time period. In yet another example, the safety verification module 03 calls the payment-related operation events that the payer account has initiated in order to improve the data processing efficiency of the server. In yet another example, the safety verification module 03 makes a general assessment of the payment operation event initiated by the payer account according to all the historic data of the payer account. In yet another example, the safety verification module 03 determines that the payment operation event initiated by the user is invalid if the server identifies any anomaly in the payment operation event. In yet another example, the safety verification module 03 determines that the payment operation event initiated by the user is valid if the server identifies no anomaly in the payment operation event. In some embodiments, the server makes a general assessment of feature information of the payer account and the payee account and verifies if the payment operation event initiated by the payer account is valid or not, hence increasing the accuracy of the server's verification on the payment operation event.

According to another embodiment, the safety verification module 03 is further configured to: according to the first feature information of the payer account and the second feature information of the payee account, send a risk prompt to the payer account if the payment operation event is verified invalid within a preset time period. For example, the amount adjustment module 04 is further configured to: if the safety verification module 03 identifies within the preset time period that the payment operation event is invalid according to the first feature information of the payer account and the second feature information of the payee account, send a risk prompt to the payer account; determine if any instruction initiated by the payer account to cancel the payment operation event is received; add the preset amount to the second balance of the payee account if within the preset time period no instruction initiated by the payer account to cancel the payment operation event is received; or refund the deducted preset amount to the payer account and add the preset amount to the first balance of the payer account if an instruction initiated by the payer account to cancel the payment operation event is received.

In some embodiments, the amount deduction module 02 deducts the preset amount corresponding to the payment operation event from the payer account on a real-time basis according to the first feature information of the payer account and the second feature information of the payee account acquired by the information acquisition module 01, but the amount deduction module 02 does not add the preset amount to the payee account in a preset time period. For instance, the amount deduction module 02 freezes the payment operation executed by the payer account, such as for 24 hours, and delays adding the same amount to the payee account after the payer account completes the payment operation and before the server notifies the payee account. In some embodiments, the preset time period may be set by the payer account, according to a default system setting, or according to the historic operation events of the payer account.

According to yet another embodiment, the information acquisition module 01 receives user operations on a user interface as shown in FIG. 2(A). For example, the user interface is displayed, and a user clicks on a functional control component (e.g., a button) “buy now” to buy a product from an online shopping mall, which is received by a server, according to certain embodiments. As shown in FIG. 2(B), a payment interface is displayed, in some embodiments. For example, the user enters a corresponding paying password and clicks on another functional control component (e.g., a button) “pay” on the payment interface to initiate a payment operation event. As an example, the server performs safety verification on the payment before adding the preset amount to the payee account. After the information acquisition module 01 receives the payment operation event initiated by the payer account based on the functional control component “pay,” the amount deduction module 02 deducts the preset amount from the first balance of the payer account on a real-time basis and displays on a client of the payer account the first balance of the payer account after the deduction, in some embodiments. For example, for the user of the payer account, the payment operations of the payer account are processed on a real-time basis, hence improving the operating experiences of the user corresponding to the payer account.

In one embodiment, when the information acquisition module 01 receives a payment operation event of RMB 100,000 initiated by a payer account A based on a third-party payment platform (e.g., Tenpay), the amount deduction module 02 deducts the amount of RMB 100,000 from the payer account A on a real-time basis. For example, instead of adding the RMB 100,000 to the corresponding payee account B immediately, the amount deduction module 02 freezes the payment operation for a preset time period in a subsequent stage of adding the amount of RMB 100,000 to the payee account, so that the safety verification module 03 can verify and ensure the safety of the payment operation event initiated by the payer account.

In another embodiment, the safety verification module 03 verifies the payment operation event initiated by the payer account according to the first feature information of the payer account and the second feature information of the payee account after the amount deduction module 02 forbids adding the preset amount to the payee account included in the second feature information of the payee account for a preset time period, which is a preset time period before the server adds the preset amount to the payee account. In order to prevent the user's normal payment operation from being affected by misjudgment of the server or any other reasons, the amount deduction module 02 freezes the payment operation to add the preset amount to the payee account within the preset time period, according to certain embodiments. For example, once the preset time period expires, the amount deduction module 02 unlocks the payment operation and the amount adjustment module 04 executes the corresponding operations according to the verification result of the payment operation event. For example, the amount adjustment module 04 executes the normal operating procedure of payment when the event is verified valid.

In some embodiments, verification of the safety verification module 03 on the payment operation event initiated by the payer account according to the first feature information of the payer account and the second feature information of the payee account includes certain operations. For example, the safety verification module 03 makes a general assessment of the payment operation event of instant payment initiated by the payer account according to the first feature information of the payer account and the second feature information of the payee account acquired by the information acquisition module 01 to see if the event directs towards a phishing website or is a malicious event set up by any hacker utilizing any system vulnerability. In another example, the safety verification module 03 identifies that the payer account does not select any valid commodity information before adding a large amount to a third-party payment platform (e.g., Tenpay) account that hasn't passed any safety verification (e.g., real name authentication). Then the safety verification module 03 calls all operating data corresponding to the operation events initiated by the same payer account corresponding to the first feature information of the payer account based on the third-party payment platform (e.g., Tenpay) payment platform, calls the feature information of the corresponding payee account and makes a general analysis of the foregoing information to verify if the payment operation event initiated by the payer account is valid or not, according to some embodiments. For example, the safety verification module 03 pushes the information to a background maintenance client where one or more background technicians make a general technical assessment on the information and return a verification result to the server; the safety verification module 03 then saves the verification result. In some embodiments, the safety verification module 03 can perform verification in other manners.

In yet another embodiment, the amount adjustment module 04 adjusts the payer account and the payee account according to the verification result of the payment operation event by the safety verification module 03. For instance, the amount adjustment module 04 adds the preset amount to the payee account if the safety verification module 03 verifies that the payment operation event is valid. In another example, the amount adjustment module 04 sends a prompt of possible safety risk to the payer account and the payer account sends an operation instruction so that the amount adjustment module 04 can execute the corresponding payment operation according to a final operation instruction from the payer account if the safety verification module 03 verifies that the payment operation event is invalid. As shown in FIG. 3, a prompt that is pushed by the amount adjustment module 04 and displayed on a client of the payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the prompt is expected to remind the payer account to execute the corresponding operation, such as canceling the corresponding payment operation or continuing the corresponding payment operation.

In yet another embodiment, the amount adjustment module 04 identifies if any instruction initiated by the payer account to cancel the payment operation event is received. For example, the amount adjustment module 04 adds the preset amount to the second balance of the payee account in order to prevent the user's normal payment operation from being affected by misjudgment if within the preset time period the amount adjustment module 04 identifies that an instruction initiated by the payer account to cancel the payment operation event is not received. In another example, the amount adjustment module 04 notifies the payee account that the preset amount is already added to the second balance of the payee account after the amount adjustment module 04 has added the preset amount to the second balance.

In yet another embodiment, the amount adjustment module 04 refunds the deducted preset amount to the payer account, adds the preset amount to the first balance of the payer account and resumes the second balance of the payee account if the amount adjustment module 04 identifies that an instruction initiated by the payer account to cancel the payment operation event is received within the preset time period. For example, the amount adjustment module 04 refunds the deducted preset amount to the payer account, adds the preset amount to the first balance of the payer account and sends a corresponding prompt to the payer account. For instance, the prompt shows: “Your *** operation may encounter a safety risk. The amount of XXX you paid has been refunded to your account *****.” In some embodiments, when the server verifies that the payment operation event initiated by the payer account is invalid, the server notifies the payer account and allow the payer account to initiate an instruction to confirm if the payment operation is continued or not instead of executing the operation of refunding the preset amount to the payer account, hence preventing the user's normal payment operation from being affected by misjudgment of the server and improving the operating experiences of the user.

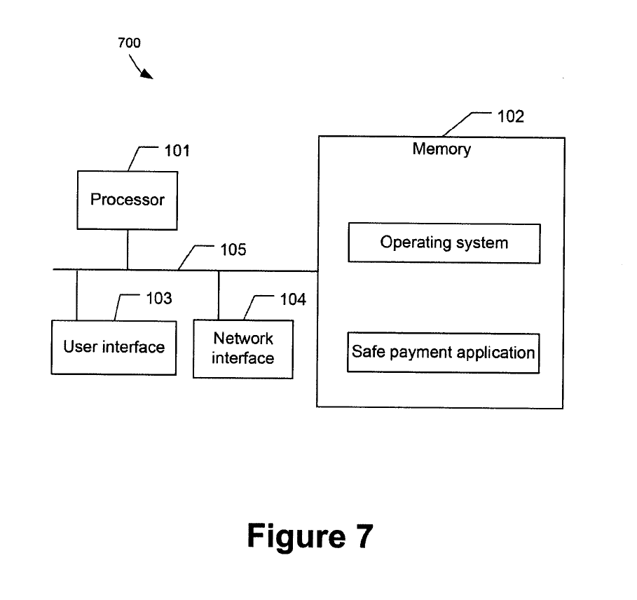

FIG. 7 is a simplified diagram showing a server for safe payments according to another embodiment of the present invention. The diagrams are merely examples, which should not unduly limit the scope of the claims. One of ordinary skill in the art would recognize many variations, alternatives, and modifications. The server 700 includes a processor 101, a memory 102, a user interface 103, a network interface 104 and a communication bus 105.

According to one embodiment, the communication bus 105 is configured for the communication among various parts of the server 700. For example, the user interface 103 is configured to receive user inputs and includes a wired interface and a wireless interface, e.g. keyboard, mouse, etc. In another example, the network interface 104 is configured for communication between the server 700 and external devices and includes a wired interface and a wireless interface. In yet another example, the memory 102 includes one or more than one computer-readable storage media, including internal memory and/or external memory. In yet another example, the memory 102 stores an operating system, a safe payment application, etc.

According to another embodiment, the processor 101 is configured to call the safe payment application stored in the memory 102 to execute operations including: receive via network interface 104 a payment operation event of a preset amount initiated by a payer account based on a third-party payment platform and acquire first feature information of the payer account and second feature information of a corresponding payee account; deduct the preset amount from the balance of the payer account according to the payment operation event; verify via the network interface 104 if the payment operation event is valid according to the first feature information of the payer account and the second feature information of the payee account; and add via the network interface 104 the preset amount to the second balance of the payee account if the payment operation event is valid.

According to yet another embodiment, the processor 101 is further configured to call the safe payment application stored in the memory 102 to execute operations including: refund via the network interface 104 the deducted preset amount to the payer account and add the preset amount to the first balance of the payer account if the payment operation event is verified invalid; and send via the user interface 103 a prompt indicating possible safety risk to the payer account if unable to confirm the validity of the payment operation event. For example, the processor 101 is further configured to call the safe payment application stored in the memory 102 to execute operations including: determine via the network interface 104 if the payee account is a trust account with real-name authentication according to the second feature information of the payee account; if the payee account is determined as a trust account with real-name authentication, according to the first feature information of the payer account, call via the network interface 104 historic data corresponding to historic operation events initiated by the payer account based on the third-party payment platform; parse the historic data to determine via the network interface 104 if the payment operation event is abnormal; verify that the payment operation event is invalid when the payment operation event is determined abnormal; and verify that the payment operation event is valid when the payment operation event is determined normal.

In one embodiment, the processor 101 is further configured to call the safe payment application stored in the memory 102 to execute operations including: verify via the communication bus 105 that the payment operation event is valid within a preset time period. For example, the processor 101 is further configured to call the safe payment application stored in the memory 102 to execute operations including: send via the user interface 103 a risk prompt to the payer account if the payment operation event is verified invalid within a preset time period via the network interface 104; determine via the user interface 103 if any instruction initiated by the payer account to cancel the payment operation event is received; and add via the network interface 104 the preset amount to the second balance of the payee account if it is determined via the user interface 103 within the preset time period that no instruction initiated by the payer account to cancel the payment operation event is received; or refund via the network interface 104 the deducted preset amount to the payer account and add the preset amount to the first balance of the payer account if it is determined via the user interface 103 that an instruction initiated by the payer account to cancel the payment operation event is received.

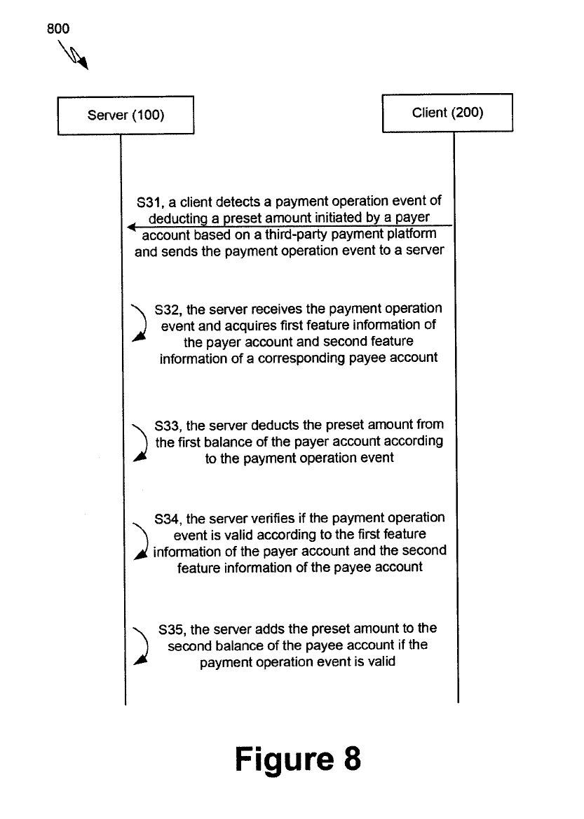

FIG. 8 is a simplified diagram showing a method for safe payments according to another embodiment of the present invention. The diagrams are merely examples, which should not unduly limit the scope of the claims. One of ordinary skill in the art would recognize many variations, alternatives, and modifications. The method 800 includes at least processes S31-S35.

According to one embodiment, during the process S31, a client detects a payment operation event of deducting a preset amount initiated by a payer account based on a third-party payment platform and sending the payment operation event to a server. For example, the client detects the payment operation event initiated by the payer account based on a third-party payment platform on a real-time basis. In another example, when the payment operation event of a preset amount initiated by the payer account based on a third-party payment platform is detected, the client sends the payment operation event to the server.

According to another embodiment, the client detects user operations on a user interface as shown in FIG. 2(A). For example, a user clicks on a functional control component “buy now” as shown in FIG. 2(A) to buy a product from an online shopping mall, inputs the corresponding paying password and clicks on a functional control component “pay” on a payment interface as shown in FIG. 2(B), which means the user initiates a payment operation event. As an example, then the client sends to the server the payment operation event initiated by the payer account and detected by the client.

According to yet another embodiment, during the process S32, the server receives the payment operation event and acquires first feature information of the payer account and second feature information of a corresponding payee account. For example, upon receipt of a payment operation event of a preset amount initiated by a payer account based on a third-party payment platform, a server corresponding to the third-party payment platform acquires the first feature information of the payer account and the second feature information of the payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

In one embodiment, during the process S33, the server deducts the preset amount from the first balance of the payer account according to the payment operation event. For example, the server deducts the preset amount corresponding to the payment operation event from the payer account on a real-time basis according to the acquired feature information of the payer account and the payee account but does not add the preset amount to the payee account simultaneously. As an example, the server freezes the payment operation executed by the payer account and delays adding, the same amount to the payee account after the payer account completes the payment operation and before the server notifies the payee account. As an example, the server performs safety verification on the payment before adding the preset amount to the payee account. After receiving the payment operation event initiated by the payer account based on the functional control component “pay,” the server deducts the preset amount from the first balance of the payer account on a real-time basis and displays on a client of the payer account the first balance of the payer account after the deduction. For example, for the user of the payer account, the payment operations of the payer account are processed on a real-time basis, hence improving the operating experiences of the user corresponding to the payer account.

According to one embodiment, when receiving a payment operation event of RMB 100,000 initiated by a payer account A based on a third-party payment platform (e.g., Tenpay), a server deducts the amount of RMB 100,000 from the payer account A on a real-time basis. For example, instead of adding the RMB 100,000 to the corresponding payee account B immediately, the server freezes the payment operation in a subsequent stage of adding the amount of RMB 100,000 to the payee account so as to verify and ensure the safety of the payment operation event initiated by the payer account.

According to another embodiment, during the process S34, the server verifies if the payment operation event is valid according to the first feature information of the payer account and the second feature information of the payee account. For example, the server verifies the payment operation event initiated by the payer account according to the first feature information of the payer account and the second feature information of the payee account after the server forbids adding the preset amount to the payee account included in the second feature information of the payee account (e.g., before the server adds the preset amount to the payee account). In some embodiments, verification of the server on the payment operation event initiated by the payer account according to the first feature information of the payer account and the second feature information of the payee account includes certain operations. For example, the server makes a general assessment of the payment operation event initiated by the payer account according to the acquired feature information of the payer account and the payee account to see if the event directs towards a phishing website or is a malicious event set up by a hacker that exploits system vulnerability. As an example, the server identifies that the payer account does not select any valid commodity information before adding a large amount to an account on a third-party payment platform (e.g., Tenpay) that hasn't passed any safety verification (e.g., real name authentication). Then the server calls all operating data corresponding, to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server pushes the information to a background maintenance client where one or more background technicians make a general technical assessment on the information and return a verification result to the server. The server then saves the verification result. Other manners of verification can be implemented, according to some embodiments.

According to yet another embodiment, during the process S35, the server adds the preset amount to the second balance of the payee account if the payment operation event is valid. For example, the server adds the preset amount to the second balance of the payee account if the verification result indicates that the payment operation event is valid. As an example, the server adds the preset amount to the second balance of the payee account if the payment operation event is verified valid. In another example, if the payment operation event is verified invalid, the server refunds the deducted preset amount to the payer account and adds the preset amount to the first balance of the payer account, thus resuming the second balance of the payee account. In yet another example, the server sends a prompt indicating possible safety risk to the payer account if the validity of the payment operation event cannot be determined.

As shown in FIG. 3, a prompt that is pushed by a server and displayed on a client of a payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the server sends help information to one or more background technicians who then make a general technical assessment on the information and return a verification result to the server. In another example, the server then executes the corresponding adjustment operations according to the verification result transmitted by the background technicians. In yet another example, the server adds the preset amount to the second balance of the payee account if the verification result transmitted from the background technicians shows that the payment operation event is valid. In yet another example, the server refunds the deducted preset amount to the payer account if the verification result transmitted from the background technicians shows that the payment operation event is invalid. In yet another example, if the verification result shows that the payment operation event is invalid, the server refunds the deducted preset amount to the payer account, adds the preset amount to the first balance of the payer account and sends a corresponding prompt to the payer account. As an example, the prompt includes: “Your *** operation may encounter a safety risk. The amount of XXX you paid has been refunded to your account ******.”

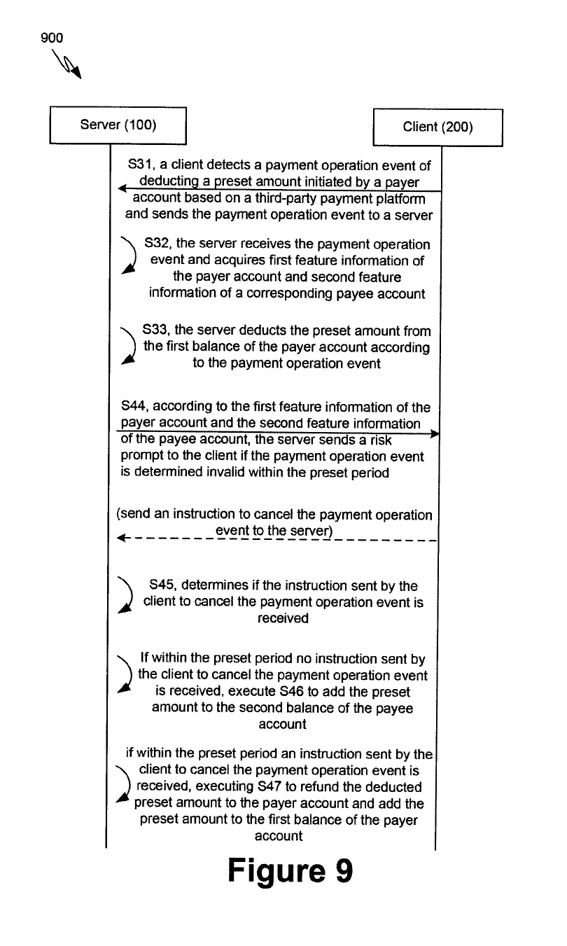

FIG. 9 is a simplified diagram showing a method for safe payments according to yet another embodiment of the present invention. The diagrams are merely examples, which should not unduly limit the scope of the claims. One of ordinary skill in the art would recognize many variations, alternatives, and modifications. The method 90 includes at least processes S31-S33 and processes S44-S47.

According to one embodiment, during the process S31, a client detects a payment operation event of deducting a preset amount initiated by a payer account based on a third-party payment platform and sends the payment operation event to a server. For example, the client detects the payment operation event initiated by the payer account based on a third-party payment platform on a real-time basis. In another example, when the payment operation event of a preset amount initiated by the payer account based on a third-party payment platform is detected, the client sends the payment operation event to the server.

According to another embodiment, the client detects user operations on a user interface as shown in FIG. 2(A). For example, a user clicks on a functional control component “buy now” as shown in FIG. 2(A) to buy a product from an online shopping mall, inputs the corresponding paying password and clicks on a functional control component “pay” on a payment interface as shown in FIG. 2(B), which means the user initiates a payment operation event. As an example, then the client sends to the server the payment operation event initiated by the payer account and detected by the client.

According to yet another embodiment, during the process S32, the server receives the payment operation event and acquires first feature information of the payer account and second feature information of a corresponding payee account. For example, upon receipt of a payment operation event of a preset amount initiated by a payer account based on a third-party payment platform, a server corresponding to the third-party payment platform acquires the first feature information of the payer account and the second feature information of the payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

In one embodiment, during the process S33, the server deducts the preset amount from the first balance of the payer account according to the payment operation event. For example, the server deducts the preset amount corresponding to the payment operation event from the payer account on a real-time basis according to the acquired feature information of the payer account and the payee account but does not add the preset amount to the payee account simultaneously. As an example, the server freezes the payment operation executed by the payer account and delays adding the same amount to the payee account after the payer account completes the payment operation and before the server notifies the payee account. As an example, the server performs safety verification on the payment before adding the preset amount to the payee account. After receiving the payment operation event initiated by the payer account based on the functional control component “pay,” the server deducts the preset amount from the first balance of the payer account on a real-time basis and displays on a client of the payer account the first balance of the payer account after the deduction. For example, for the user of the payer account, the payment operations of the payer account are processed on a real-time basis, hence improving the operating experiences of the user corresponding to the payer account.

According to one embodiment, when receiving a payment operation event of RMB 100,000 initiated by a payer account A based on a third-party payment platform (e.g., Tenpay), a server deducts the amount of RMB 100,000 from the payer account A on a real-time basis. For example, instead of adding the RMB 100,000 to the corresponding payee account B immediately, the server freezes the payment operation in a subsequent stage of adding the amount of RMB 100,000 to the payee account so as to verify and ensure the safety of the payment operation event initiated by the payer account.

According to another embodiment, during the process S44, according to the first feature information of the payer account and the second feature information of the payee account, the server sends a risk prompt to the client if the payment operation event is verified invalid within the preset time period. For example, the server verifies the payment operation event initiated by the payer account according to the first feature information of the payer account and the second feature information of the payee account after the server forbids adding the preset amount to the payee account included in the second feature information or the payee account for a preset time period, which is a preset time period before the server adds the preset amount to the payee account. In order to prevent the user's normal payment operation from being affected by misjudgment of the server or any other reasons, the server freezes the payment operation to add the preset amount to the payee account within the preset time period, according to certain embodiments. Once the preset time period expires, the server unlocks the payment operation and executes the corresponding operations according to the verification result of the payment operation event. For example, the server executes the normal operating procedure of payment when the event is verified valid.

In some embodiments, verification of the server on the payment operation event initiated by the payer account according to the first feature information of the payer account and the second feature information of the payee account includes certain operations. For example, the server makes a general assessment of the payment operation event initiated by the payer account according to the acquired feature information of the payer account and the payee account to see if the event directs towards a phishing website or is a malicious event set up by a hacker that exploits system vulnerability. As an example, the server identifies that the payer account does not select any valid commodity information before adding a large amount to an account on a third-party payment platform (e.g., Tenpay) that hasn't passed any safety verification (e.g., real name authentication). Then the server calls all operating data corresponding to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server pushes the information to a background maintenance client where one or more background technicians make a general technical assessment on the information and return a verification result to the server. The server then saves the verification result. Other manners of verification can be implemented, according to some embodiments.

In certain embodiments, the server adjusts the payer account and the payee account according to the verification result of the payment operation event. For instance, the server adds the preset amount to the payee account if the payment operation event is verified valid. In another example, the server sends a prompt of possible safety risk to the payer account and the payer account sends an operation instruction so that the server can execute the corresponding payment operation according to a final operation instruction from the payer account if the payment operation event is determined to be invalid. As shown in FIG. 3, a prompt that is pushed by a server and displayed on a client of a payer account shows: “There is a safety risk related to your payment for your purchase of XXX product. Do you want to continue the payment of RMB XXX.XX to the seller ***? If you want to cancel the payment, please execute operations including: ********,” according to certain embodiments. For example, the prompt is expected to remind the payer account to execute the corresponding operation, such as canceling the corresponding payment operation or continuing the corresponding payment operation.

According to yet another embodiment, the process S45 includes: determining if any instruction initiated by the payer account to cancel the payment operation event is received. For example, if no instruction initiated by the payer account to cancel the payment operation event is received, the process S46 is executed. In another example, if an instruction initiated by the payer account to cancel the payment operation event is received, the process S47 is executed. As an example, the process S46 includes: adding the preset amount to the second balance of the payee account. As another example, the process S47 includes: refunding the deducted preset amount to the payer account and adding the preset amount to the first balance of the payer account.

In some embodiments, the server identifies if any instruction initiated by the payer account to cancel the payment operation event is received. For example, the server adds the preset amount to the second balance of the payee account in order to prevent the user's normal payment operation from being affected by misjudgment of the server if the instruction initiated by the payer account to cancel the payment operation event is not received within the preset time period. In another example, the server notifies the payee account that the preset amount is already added to the second balance of the payee account after the server has added the preset amount to the second balance.

In certain embodiments, the server refunds the deducted preset amount to the payer account, adds the preset amount to the first balance of the payer account and resumes the second balance of the payee account if the server identifies that an instruction initiated by the payer account to cancel the payment operation event is received within the preset time period. For example, the server refunds the deducted preset amount to the payer account, adds the preset amount to the first balance of the payer account and sends a corresponding prompt to the payer account. As an example, the prompt may be as follows: “Your *** operation may encounter a safety risk. The amount of XXX you paid has been refunded to your account *****.” In some embodiments, when the server verifies that the payment operation event initiated by the payer account is invalid, the server notifies the payer account and allows the payer account to initiate an instruction to confirm if the payment operation is continued or not instead of executing the operation of refunding the preset amount to the payer account, hence preventing the user's normal payment operation from being affected by misjudgment of the server and improving the operating experiences of the user.

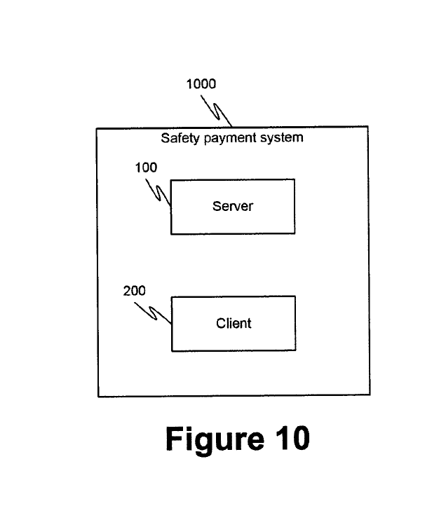

FIG. 10 is a simplified diagram showing a system for safe payments according to one embodiment of the present invention. The diagrams are merely examples, which should not unduly limit the scope of the claims. One of ordinary skill in the art would recognize many variations, alternatives, and modifications. The system 1000 includes a server 100 and a client 200 corresponding to the payer account.

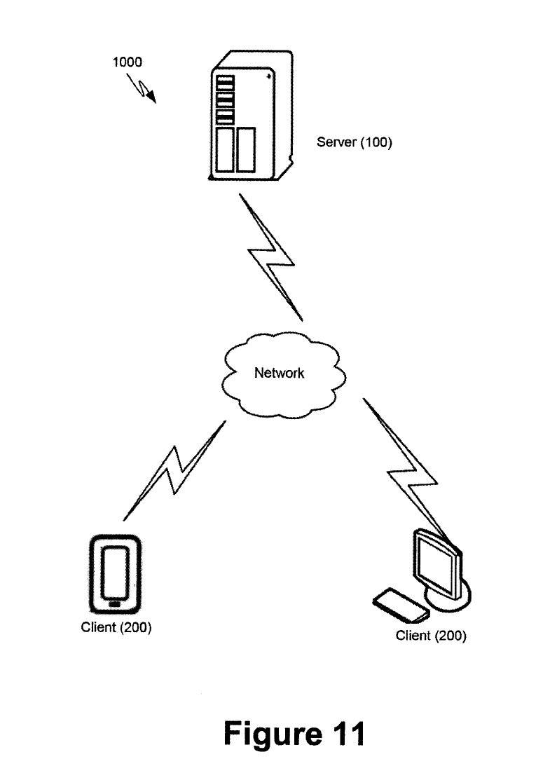

FIG. 11 is a simplified diagram showing an operating environment for the system as shown in FIG. 10 according to one embodiment of the present invention. The diagrams are merely examples, which should not unduly limit the scope of the claims. One of ordinary skill in the art would recognize many variations, alternatives, and modifications.

As shown in FIG. 11, the client 200 communicates and exchanges data with the server 100 via the Internet, according to one embodiment. For example, the client 200 includes a personal computer, a smart phone (e.g., an Android phone, an iOS phone, etc.), a tablet computer, a personal digital assistant, a mobile Internet device (MID), a PAD and any other mobile devices. As an example, the client 200 is configured to detect a payment operation event of a preset amount initiated by a payer account based on a third-party payment platform and send the payment operation event to the server 100. In another example, the client 200 detects the payment operation event initiated by the payer account based on a third-party payment platform on a real-time basis. In yet another example, when the payment operation event of a preset amount initiated by the payer account based on a third-party payment platform is detected, the client 200 sends the payment operation event to the server 100.

According to one embodiment, the client 200 detects user operations on a user interface as shown in FIG. 2(A). For example, a user clicks on a functional control component (e.g., a button) “buy now” as shown in FIG. 2(A) to buy a product from an online shopping mall, according to certain embodiments. As shown in FIG. 2(B), a payment interface is displayed, in some embodiments. For example, the user enters a corresponding paying password and clicks on another functional control component (e.g., a button) “pay” on the payment interface to initiate a payment operation event. As an example, the client 200 sends to the server 100 the payment operation event initiated by the payer account and detected by the client 200.

According to another embodiment, the server 100 is configured to: receive the payment operation event and acquire first feature information of the payer account and second feature information of a corresponding payee account; deduct the preset amount from the first balance of the payer account on a real-time basis and forbid adding the preset amount to the payee account at the same time; verify if the payment operation event is valid according to the first feature information of the payer account and the second feature information of the payee account; and add the preset amount to the second balance of the payee account if the payment operation event is valid. For example, upon receipt of a payment operation event of a preset amount initiated by a payer account based on a third-party payment platform, the server 100 acquires the first feature information of the payer account and the second feature information of the payee account. As an example, the first feature information of the payer account includes the payer account, a bank associated with the payer account, a total balance of the payer account, identity information associated with the payer account, etc., where the identity information associated with the payer account includes a real name of an owner of the payer account, an ID card number of the owner of the payer account, a telephone number provided upon registration of the payer account, a username and a password of the payer account for login onto the third-party payment platform, and a paying account and a paying password of the third-party payment platform. As another example, the second feature information of the payee account includes a payee account, a bank associated with the payee account and identity information associated with the payee account, where the identity information associated with the payee account includes a telephone number provided upon registration of the payee account, a username of the payee account for login onto the third-party payment platform and a paying account of the third-party payment platform.

In some embodiments, the payment operation event of a preset amount initiated by the payer account includes the payer account executing deduction of a target amount, e.g. in excess of RMB 100,000. For example, when the payer account deducts the preset amount based on the server corresponding to the third-party payment platform, the server 100 receives the preset amount deducted by the payer account and then adds the preset amount to the corresponding payee account on a real-time basis or after a certain time period (e.g. 24 hours), hence eliminating the need for the payer account to initiate an operation instruction to confirm the payment based on the third-party payment platform. In another example, the third-party payment platform integrates a plurality of bank card payment modes onto a single interface between various parties of an E-commerce transaction and the bank, and is responsible for interfacing with the bank during account settlement. As an example, consumers pay to merchants via the third-party payment platform, and the third-party payment platform provides to the merchants an interface platform compatible with various bank payment modes. In another example, the third-party payment platform may include one or more of: 99Bill, Lakala, Tenpay, ePay and WeChat Payment.

In one embodiment, the server 100 deducts the preset amount corresponding to the payment operation event from the payer account on a real-time basis according to the acquired feature information of the payer account and the payee account but does not add the preset amount to the payee account simultaneously. As an example, the server 100 freezes the payment operation executed by the payer account and delays adding the same amount to the payee account after the payer account completes the payment operation and before the server notifies the payee account. As another example, the server 100 performs safety verification on the payment before adding the preset amount to the payee account. After receiving the payment operation event initiated by the payer account based on the functional control component “pay,” the server 100 deducts the preset amount from the first balance of the payer account on a real-time basis and displays on the client 200 of the payer account the first balance of the payer account after the deduction. For example, for the user of the payer account, the payment operations of the payer account are processed on a real-time basis, hence improving the operating experiences of the user corresponding to the payer account.

According to another embodiment, when receiving a payment operation event of RMB 100,000 initiated by a payer account A based on a third-party payment platform (e.g., Tenpay), the server 100 deducts the amount of RMB 100,000 from the payer account A on a real-time basis. For example, instead of adding the RMB 100,000 to the corresponding payee account B immediately, the server 100 freezes the payment operation in a subsequent stage of adding the amount of RMB 100,000 to the payee account so as to verify and ensure the safety of the payment operation event initiated by the payer account. In another example, the server 100 verifies the payment operation event initiated by the payer account according to the first feature information of the payer account and the second feature information of the payee account after the server 100 forbids adding the preset amount to the payee account included in the second feature information of the payee account (e.g., before the server adds the preset amount to the payee account). In some embodiments, verification of the server 100 on the payment operation event initiated by the payer account according to the first feature information of the payer account and the second feature information of the payee account includes certain operations. For example, the server 100 makes a general assessment of the payment operation event initiated by the payer account according to the acquired feature information of the payer account and the payee account to see if the event directs towards a phishing website or is a malicious event set up by a hacker that exploits system vulnerability. As an example, the server 100 identifies that the payer account does not select any valid commodity information before adding a large amount to an account on a third-parry payment platform (e.g., Tenpay) that hasn't passed any safety verification (e.g., real name authentication). Then the server 100 calls all operating data corresponding to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server 100 pushes the information to the client 200 for background maintenance where one or more background technicians make a general technical assessment on the information and return a verification result to the server 100. The server 100 then saves the verification result. Other manners of verification can be implemented, according to some embodiments.

According to yet another embodiment, the server 100 adds the preset amount to the second balance of the payee account if the verification result indicates that the payment operation event is valid. As an example, the server 100 adds the preset amount to the second balance of the payee account if the payment operation event is verified valid. In another example, if the payment operation event is verified invalid, the server refunds the deducted preset amount to the payer account and adds the preset amount to the first balance of the payer account, thus resuming the second balance of the payee account. In yet another example, the server 100 sends a prompt indicating possible safety risk to the payer account if the validity of the payment operation event cannot be determined.

As shown in FIG. 3, a prompt that is pushed by the server 100 and displayed on the client 200 shows: “There is a safety risk related to your payment for your purchase of XXX product. Do you want to continue the payment of RMB XXX.XX to the seller ***? If you want to cancel the payment, please execute operations including: ********,” according to certain embodiments. For example, the server 100 sends help information to one or more background technicians who then make a general technical assessment on the information and return a verification result to the server 100. In another example, the server 100 then executes the corresponding adjustment operations according to the verification result transmitted by the background technicians. In yet another example, the server 100 adds the preset amount to the second balance of the payee account if the verification result transmitted from the background technicians shows that the payment operation event is valid. In yet another example, the server 100 refunds the deducted preset amount to the payer account if the verification result transmitted from the background technicians shows that the payment operation event is invalid. In yet another example, if the verification result shows that the payment operation event is invalid, the server 100 refunds the deducted preset amount to the payer account, adds the preset amount to the first balance of the payer account and sends a corresponding prompt to the payer account. As an example, the prompt includes: “Your *** operation may encounter a safety risk. The amount of XXX you paid has been refunded to your account ******.”

In some embodiments, the server 100 is further configured to: send a risk prompt to the client 200 if the payment operation event is verified invalid within the preset time period according to the first feature information of the payer account and the second feature information of the payee account; determine if any instruction sent by the client 200 to cancel the payment operation event is received; and add the preset amount to the second balance of the payee account if it is determined within the preset time period that no instruction sent by the client 200 to cancel the payment operation event is received; or refund the deducted preset amount to the payer account if it is determined that an instruction sent by the client 200 to cancel the payment operation event is received. For example, the server 100 deducts the preset amount corresponding to the payment operation event from the payer account on a real-time basis according to the acquired feature information of the payer account and the payee account and forbids adding the preset amount to the payee account within a preset time period. In another example, the server 100 freezes the payment operation executed by the payer account, such as for 24 hours, and delays adding the same amount to the payee account after the payer account completes the payment operation and before the server 100 notifies the payee account. In some embodiments, the preset time period may be set by the payer account, according to a default system setting or according to historic operation events of the payer account.

In certain embodiments, the server 100 receives user operations on a user interface as shown in FIG. 2(A). For example, the user clicks on the functional control component “buy now” as shown in FIG. 2(A) to buy a product from an online shopping mall, inputs the corresponding paying password and clicks on the functional control component “pay” on a payment interface as shown in FIG. 2(B) to initiate a payment operation event. As an example, the server 100 performs safety verification on the payment before adding the preset amount to the payee account, so after receiving the payment operation event initiated by the payer account based on the functional control component “pay,” the server 100 deducts the preset amount from the first balance of the payer account on a real-time basis and displays on the payer account client 200 the first balance of the payer account after such deduction. In another example, for the user of the payer account, the payment operation of the payer account is processed on a real-time basis, hence improving the operating experiences of the user corresponding to the payer account.

According to another embodiment, when receiving a payment operation event of RMB 100,000 initiated by a payer account A based on a third-party payment platform (e.g., Tenpay), the server 100 deducts the amount of RMB 100,000 from the payer account A on a real-time basis. For example, instead of adding the RMB 100,000 to the corresponding payee account B immediately, the server 100 freezes the payment operation in a subsequent stage of adding the amount of RMB 100,000 to the payee account so as to verify and ensure the safety of the payment operation event initiated by the payer account. In another example, the server 100 verifies the payment operation event initiated by the payer account according to the first feature information of the payer account and the second feature information of the payee account after the server 100 forbids adding the preset amount to the payee account included in the second feature information of the payee account for a preset time period, which is a preset time period before the server 100 adds the preset amount to the payee account. In order to prevent the user's normal payment operation from being affected by misjudgment of the server 100 or any other reasons, the server 100 freezes the payment operation to add the preset amount to the payee account within the preset time period, according to some embodiments. For example, once the preset period expires, the server 100 unlocks the payment operation and executes the corresponding operations according to the verification result of the payment operation event. As an example, the server 100 executes the normal operating procedure of payment when the event is verified valid.

In some embodiments, verification of the server 100 on the payment operation event initiated by the payer account according to the first feature information of the payer account and the second feature information of the payee account includes certain operations. For example, the server 100 makes a general assessment of the payment operation event initiated by the payer account according to the acquired feature information of the payer account and the payee account to see if the event directs towards a phishing website or is a malicious event set up by a hacker that exploits system vulnerability. As an example, the server 100 identifies that the payer account does not select any valid commodity information before adding a large amount to an account on a third-party payment platform (e.g., Tenpay) that hasn't passed any safety verification (e.g., real name authentication). Then the server 100 calls all operating data corresponding to the operation events initiated by the same payer account based on the third-party payment platform (e.g., Tenpay), calls the feature information of the corresponding payee account and makes a general analysis of the information to verify if the payment operation event initiated by the payer account is valid or not. As another example, the server 100 pushes the information to the client 200 for background maintenance where one or more background technicians make a general technical assessment on the information and return a verification result to the server 100. The server 100 then saves the verification result. Other manners of verification can be implemented, according to some embodiments.

In one embodiment, the server 100 adjusts the payer account and the payee account according to the verification result of the payment operation event. For instance, the server 100 adds the preset amount to the payee account if the payment operation event is verified valid. In another example, the server 100 sends a prompt of possible safety risk to the client 200 and the client 200 sends an operation instruction to the server 100 so that the server 100 can execute the corresponding payment operation according to the final operation instruction from the client 200 if the payment operation event is verified invalid.

As shown in FIG. 3, a prompt that is pushed by the server 100 and displayed on the client 200 shows: “There is a safety risk related to your payment for your purchase of XXX product. Do you want to continue the payment of RMB XXX.XX to the seller ***? If you want to cancel the payment, please execute operations including: ********,” according to certain embodiments. For example, the prompt is expected to remind the client 200 to execute the corresponding operation, such as canceling the corresponding payment operation or continuing the corresponding payment operation. As an example, the server 100 identifies if any instruction sent by the client 200 to cancel the payment operation event is received. In one example, the server 100 adds the preset amount to the second balance of the payee account in order to prevent the user's normal payment operation from being affected by misjudgment if an instruction sent by the client 200 to cancel the payment operation event is not received within the preset time period. In another example, the server 100 notifies the payee account that the preset amount is already added to the second balance of the payee account after the server 100 has added the preset amount to the second balance.

In another embodiment, the server 100 refunds the deducted preset amount to the payer account, adds the preset amount to the first balance of the payer account and resumes the second balance of the payee account if the server 100 identifies that an instruction sent by the client 200 to cancel the payment operation event is received within the preset time period. For example, the server 100 refunds the deducted preset amount to the payer account, adds the preset amount to the first balance of the payer account and sends a corresponding prompt to the client 200. As an example, a prompt shows: “Your *** operation may encounter a safety risk. The amount of XXX you paid has been refunded to your account *****.” In some embodiments, when the server 100 verifies that the payment operation event initiated by the payer account is invalid, the server 100 notifies the client 200 and allow the client 200 to initiate an instruction to confirm if the payment operation is continued or not instead of executing the operation of refunding the preset amount to the payer account, hence preventing the user's normal payment operation from being affected by misjudgment of the server and improving the operating experiences of the user.

According to one embodiment, a method is provided for safe payments. For example, a payment operation event of deducting a preset amount initiated by a payer account based on a third-party payment platform is received; first feature information of the payer account and second feature information of a corresponding payee account are acquired; the preset amount is deducted from a first balance of the payer account according to the payment operation event; if the payment operation event is valid is determined according to the first feature information of the payer account and the second feature information of the payee account; and in response to the payment operation event being determined to be valid, the preset amount is added to a second balance of the payee account. For example, the method is implemented according to at least FIG. 1.

According to another embodiment, a server for safe payments includes: an information acquisition module configured to receive a payment operation event of deducting a preset amount initiated by a payer account based on a third-party payment platform and acquire first feature information of the payer account and second feature information of a corresponding payee account; an amount deduction module configured to deduct the preset amount from a first balance of the payer account according to the payment operation event; a safety verification module configured to determine if the payment operation event is valid according to the first feature information of the payer account and the second feature information of the payee account; and an amount adjustment module configured, in response to the payment operation event being determined to be valid, to add the preset amount to a second balance of the payee account. For example, the server is implemented according to at least FIG. 6.

According to yet another embodiment, a method is provided for safe payments. A client detects a payment operation event of deducting a preset amount initiated by a payer account based on a third-party payment platform; the client sends the payment operation event to a server; the server receives the payment operation event; the server acquires first feature information of the payer account and second feature information of a corresponding payee account; the server deducts the preset amount from a first balance of the payer account according to the payment operation event; the server determines if the payment operation event is valid according to the first feature information of the payer account and the second feature information of the payee account; and in response to the payment operation event being determined to be valid, the server adds the preset amount to a second balance of the payee account. For example, the method is implemented according to at least FIG. 8 and/or FIG. 9.

In one embodiment, a system for safe payments includes: a server and a client corresponding to a payer account. The client is configured to detect a payment operation event of deducting a preset amount initiated by the payer account based on a third-party payment platform and send the payment operation event to a server. The server is configured to: receive the payment operation event; acquire first feature information of the payer account and second feature information of a corresponding payee account; deduct the preset amount from a first balance of the payer account according to the payment operation event; determine if the payment operation event is valid according to the first feature information of the payer account and the second feature information of the payee account; and in response to the payment operation event being determined to be valid, add the preset amount to a second balance of the payee account. For example, the system is implemented according to at least FIG. 8, FIG. 9, FIG. 10, and/or FIG. 11.

In another embodiment, a non-transitory computer readable storage medium includes programming instructions for safe payment. The programming instructions are configured to cause one or more data processors to execute certain operations. For example, a payment operation event of deducting a preset amount initiated by a payer account based on a third-party payment platform is received; first feature information of the payer account and second feature information of a corresponding payee account are acquired; the preset amount is deducted from a first balance of the payer account according to the payment operation event; if the payment operation event is valid is determined according to the first feature information of the payer account and the second feature information of the payee account; and in response to the payment operation event being determined to be valid, the preset amount is added to a second balance of the payee account. For example, the storage medium is implemented according to at least FIG. 1.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A method for safe payments, comprising:
receiving a payment operation event of deducting a preset amount initiated by a payer account based on a third-party payment platform;
acquiring first feature information of the payer account and second feature information of a corresponding payee account;
deducting the preset amount from a first balance of the payer account according to the payment operation event;
determining if the payment operation event is valid according to the first feature information of the payer account and the second feature information of the payee account; and
in response to the payment operation event being determined to be valid, adding the preset amount to a second balance of the payee account.

2. The method of claim 1, further comprising:
in response to the payment operation event being determined to be invalid,
refunding the deducted preset amount to the payer account; and
adding the preset amount to the first balance of the payer account; and
in response to the payment operation event not being determined to be valid or invalid, sending a prompt indicating possible safety risk to the payer account.

3. The method of claim 1, wherein the determining if the payment operation event is valid according to the first feature information of the payer account and the second feature information of the payee account includes:
determining if the payee account is a trust account with real-name authentication according to the second feature information of the payee account;
in response to the payee account being determined to be a trust account with real-name authentication, calling historic data corresponding to historic operation events initiated by the payer account based on the third-party payment platform according to the first feature information of the payer account;
parsing the historic data to determine if the payment operation event is abnormal;
in response to the payment operation event being determined to be abnormal, determining that the payment operation event is invalid; and
in response to the payment operation event being determined to be normal, determining that the payment operation event is valid.

4. The method of claim 1, wherein the determining if the payment operation event is valid according to the first feature information of the payer account and the second feature information of the payee account includes:
determining within a preset time period if the payment operation event is valid.

5. The method of claim 4, further comprising:
in response to the payment operation event being determined to be invalid within the preset time period, sending a risk prompt to the payer account;
determining if an instruction initiated by the payer account to cancel the payment operation event is received;
in response to the instruction initiated by the payer account to cancel the payment operation event not being received within the preset time period, adding the preset amount to the second balance of the payee account; and
in response to the instruction initiated by the payer account to cancel the payment operation event being received within the preset time period,
refunding the deducted preset amount to the payer account; and
adding the preset amount to the first balance of the payer account.

6. A server for safe payments comprising:
an information acquisition module configured to receive a payment operation event of deducting a preset amount initiated by a payer account based on a third-party payment platform and acquire first feature information of the payer account and second feature information of a corresponding payee account;
an amount deduction module configured to deduct the preset amount from a first balance of the payer account according to the payment operation event;
a safety verification module configured to determine if the payment operation event is valid according to the first feature information of the payer account and the second feature information of the payee account; and
an amount adjustment module configured, in response to the payment operation event being determined to be valid, to add the preset amount to a second balance of the payee account.

7. The server of claim 6, wherein the amount adjustment module is further configured to:
in response to the payment operation event being determined to be invalid,
refund the deducted preset amount to the payer account; and
add the preset amount to the first balance of the payer account; and
in response to the payment operation event not being determined to be valid or invalid, send a prompt indicating possible safety risk to the payer account.

8. The server of claim 6, wherein the safety verification module is further configured to:
determine if the payee account is a trust account with real-name authentication according to the second feature information of the payee account;
in response to the payee account being determined to be a trust account with real-name authentication, call historic data corresponding to historic operation events initiated by the payer account based on the third-party payment platform according to the first feature information of the payer account;
parse the historic data to determine if the payment operation event is abnormal;
in response to the payment operation event being determined to be abnormal, determine that the payment operation event is invalid; and
in response to the payment operation event being determined to be normal, determine that the payment operation event is valid.

9. The server of claim 6, wherein the safety verification module is further configured to:
determine within a preset time period if the payment operation event is valid.

10. The server of claim 9, wherein the amount adjustment module is further configured to:
send a risk prompt to the payer account if the payment operation event is determined to be invalid within the preset time period;
determine if an instruction initiated by the payer account to cancel the payment operation event is received;
in response to the instruction initiated by the payer account to cancel the payment operation event not being received within the preset time period, add the preset amount to the second balance of the payee account; and
in response to the instruction initiated by the payer account to cancel the payment operation event being received within the preset time period,
refund the deducted preset amount to the payer account; and
add the preset amount to the first balance of the payer account.

11. The server of claim 6, further comprising:
one or more data processors; and
a computer-readable storage medium;
wherein the information acquisition module, the amount deduction module, the safety verification module, and the amount adjustment module are stored in the storage medium and configured to be executed by the one or more data processors.

12. A method for safe payments, comprising:
detecting, by a client, a payment operation event of deducting a preset amount initiated by a payer account based on a third-party payment platform;
sending, by the client, the payment operation event to a server;
receiving, by the server, the payment operation event;
acquiring, by the server, first feature information of the payer account and second feature information of a corresponding payee account;
deducting, by the server, the preset amount from a first balance of the payer account according to the payment operation event;
determining, by the server, if the payment operation event is valid according to the first feature information of the payer account and the second feature information of the payee account; and
in response to the payment operation event being determined to be valid, adding, by the server, the preset amount to a second balance of the payee account.

13. The method of claim 12, further comprising:
in response to the payment operation event being determined to be invalid,
refunding, by the server, the deducted preset amount to the payer account; and
adding, by the server, the preset amount to the first balance of the payer account; and
in response to the payment operation event not being determined to be valid or invalid, sending, by the server, a prompt indicating possible safety risk to the payer account.

14. The method of claim 12, wherein the determining, by the server, if the payment operation event is valid according to the first feature information of the payer account and the second feature information of the payee account includes:
determining, by the server, within a preset time period if the payment operation event is valid.

15. The method of claim 14, further comprising:
sending, by the server, a risk prompt to the payer account if the payment operation event is determined to be invalid within the preset time period;
determining, by the server, if an instruction initiated by the payer account to cancel the payment operation event is received; and
in response to the instruction initiated by the payer account to cancel the payment operation event not being received within the preset time period, adding, by the server, the preset amount to the second balance of the payee account; and
in response to the instruction initiated by the payer account to cancel the payment operation event being received within the preset time period,
refunding, by the server, the deducted preset amount to the payer account; and
adding, by the server, the preset amount to the first balance of the payer account.

16. A system for safe payments comprising:
a server; and
a client corresponding to a payer account;
wherein:
the client is configured to detect a payment operation event of deducting a preset amount initiated by the payer account based on a third-party payment platform and send the payment operation event to a server; and
the server is configured to:
receive the payment operation event;
acquire first feature information of the payer account and second feature information of a corresponding payee account;
deduct the preset amount from a first balance of the payer account according to the payment operation event;
determine if the payment operation event is valid according to the first feature information of the payer account and the second feature information of the payee account; and
in response to the payment operation event being determined to be valid, add the preset amount to a second balance of the payee account.

17. The system for safe payment of claim 16, wherein the server is further configured to:
in response to the payment operation event being determined to be invalid,
refund the deducted preset amount to the payer account; and
add the preset amount to the first balance of the payer account; and
in response to the payment operation event not being determined to be valid or invalid, send a prompt indicating possible safety risk to the payer account.

18. The system for safe payment of claim 16, wherein the server is further configured to:
determine within a preset time period if the payment operation event is valid.

19. The system for safe payment of claim 18, wherein the server is further configured to:
send a risk prompt to the payer account if the payment operation event is determined to be invalid within the preset time period;
determine if an instruction initiated by the payer account to cancel the payment operation event is received; and
in response to the instruction initiated by the payer account to cancel the payment operation event not being received within the preset time period, add the preset amount to the second balance of the payee account; and
in response to the instruction initiated by the payer account to cancel the payment operation event being received within the preset time period,
refund the deducted preset amount to the payer account; and
add the preset amount to the first balance of the payer account.

20. A non-transitory computer readable storage medium comprising programming instructions for safe payment, the programming instructions configured to cause one or more data processors to execute operations comprising:
receiving a payment operation event of deducting a preset amount initiated by a payer account based on a third-party payment platform;
acquiring first feature information of the payer account and second feature information of a corresponding payee account;
deducting the preset amount from a first balance of the payer account according to the payment operation event;
determining if the payment operation event is valid according to the first feature information of the payer account and the second feature information of the payee account; and
in response to the payment operation event being determined to be valid, adding the preset amount to a second balance of the payee account.
